(19) United States
(12) Patent Application Publication
(10) Pub. No.: US 2019/0297210 A1
(43) Pub. Date: Sep. 26, 2019

(54) IMAGE FORMING APPARATUS AND IMAGE FORMING METHOD

(71) Applicants: KABUSHIKI KAISHA TOSHIBA, Tokyo (JP); TOSHIBA TEC KABUSHIKI KAISHA, Tokyo (JP)

(72) Inventor: Kimihiko Hiyoshi, Numazu Shizuoka (JP)

(21) Appl. No.: 15/933,465

(22) Filed: Mar. 23, 2018

(51) Int. Cl. H04N 1/00

(52) U.S. Cl. CPC H04N 1/00652; H04N 1/00742

(57) ABSTRACT

According to one embodiment, an image forming apparatus includes a speed information obtaining unit, a speed measuring unit, and a determining unit. The speed information obtaining unit obtains a printing speed of a rated value of the image forming apparatus. The speed measuring unit determines a measured speed which denotes a printing speed when a sheet is printed by the image forming apparatus. The determining unit determines that the image forming apparatus is subjected to a modification when the printing speed and the measured speed satisfy a predetermined condition.

### FIELD

Embodiments described herein relate generally to an image forming apparatus and an image forming method.

### BACKGROUND

An image forming apparatus has a different printing speed according to a model. For example, when the apparatus is an inexpensive model, it has a printing speed in which approximately 25 pieces can be printed per minute; however, in contrast to this, when the apparatus is an expensive model, it has a printing speed in which approximately 50 pieces can be printed per minute. However, there is a case in which a user of an image forming apparatus performs an unfair modification such as an exchange of a substrate or updating of software with respect to the image forming apparatus. There was a case in which the image forming apparatus subjected to the unfair modification can perform printing at the same printing speed as that of an expensive model or more, even when it is an inexpensive model.

### DESCRIPTION OF THE DRAWINGS

FIG. 1 is an external diagram which illustrates the entire configuration example of an image forming apparatus according to an embodiment.

FIG. 2 is a diagram which illustrates an example of a built-in place of an IC tag which is built in the image forming apparatus in the embodiment.

FIG. 3 is a functional block diagram which illustrates a configuration of the image forming apparatus in the embodiment.

FIG. 4 is a diagram which illustrates a specific example of a billing information table in the embodiment.

FIG. 5 is a flowchart which illustrates a flow of determining whether or not there is an unfair modification in the image forming apparatus in the embodiment.

FIG. 6 is a flowchart which illustrates a flow of determining whether or not there is an unfair modification in the image forming apparatus in the embodiment.

FIG. 7 is a diagram which illustrates a second specific example of a billing information table in the embodiment.

### DETAILED DESCRIPTION

An image forming apparatus according to an embodiment is provided with a speed information obtaining unit, a speed measuring unit, and a determining unit. The speed information obtaining unit obtains a printing speed of a rated value of the image forming apparatus. The speed measuring unit determines a measured speed which denotes a printing speed when a sheet is printed by the image forming apparatus. The determining unit determines that the image forming apparatus was subjected to a modification when the printing speed and the measured speed satisfy a predetermined condition.

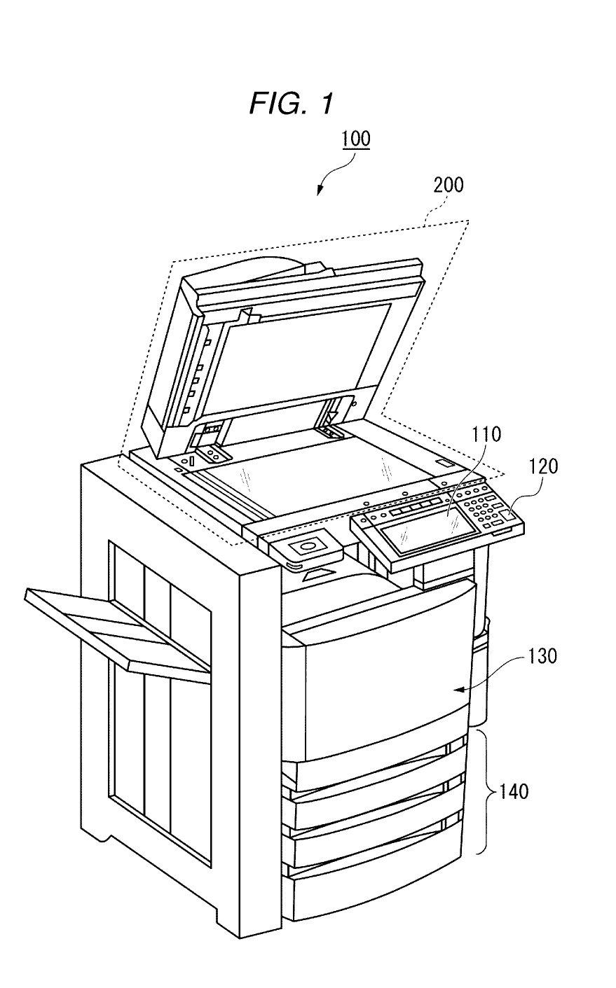

FIG. 1 is an external view which illustrates the entire configuration example of an image forming apparatus 100 in the embodiment. The image forming apparatus 100 is a multifunction peripheral, for example. The image forming apparatus 100 is provided with a display 110, a control panel 120, a printing unit 130, a sheet accommodating unit 140, and an image reading unit 200. The printing unit 130 of the image forming apparatus 100 may be a unit which fixes a toner image, or an ink jet unit.

The image forming apparatus 100 forms an image on a sheet using a developing agent such as toner. The sheet is, for example, paper or label paper. The sheet may be any sheet when the image forming apparatus 100 can form an image on the front surface thereof.

The display 110 is an image display device such as a liquid crystal display, or an organic electro luminescence (EL) display. The display 110 displays various information related to the image forming apparatus 100.

The control panel 120 includes a plurality of buttons. The control panel 120 receives an operation of a user. The control panel 120 outputs a signal corresponding to the operation performed by the user to a control unit of the image forming apparatus 100. In addition, the display 110 and the control panel 120 may be configured as an integrated touch panel.

The printing unit 130 forms an image on a sheet based on image information which is generated by the image reading unit 200, or image information received through a communication path. The printing unit 130 forms an image through the following processing, for example. An image forming unit of the printing unit 130 forms an electrostatic latent image on a photoconductive drum based on image information. The image forming unit of the printing unit 130 forms a visible image by fixing a developing agent to the electrostatic latent image. As a specific example of the developing agent, there is toner. A transfer unit of the printing unit 130 transfers the visible image on the sheet. A fixing unit of the printing unit 130 fixes the visible image onto the sheet by heating and pressurizing the sheet. In addition, the sheet on which an image is formed may be a sheet which is accommodated in the sheet accommodating unit 140, or may be a sheet which is manually accommodated.

The sheet accommodating unit 140 accommodates a sheet which is used in image forming in the printing unit 130.

The image reading unit 200 reads image information which is a reading target as brightness and darkness of light. The image reading unit 200 records the read image information. The recorded image information may be transmitted to another information processing device through a network. The recorded image information may be formed as an image on a sheet using the printing unit 130.

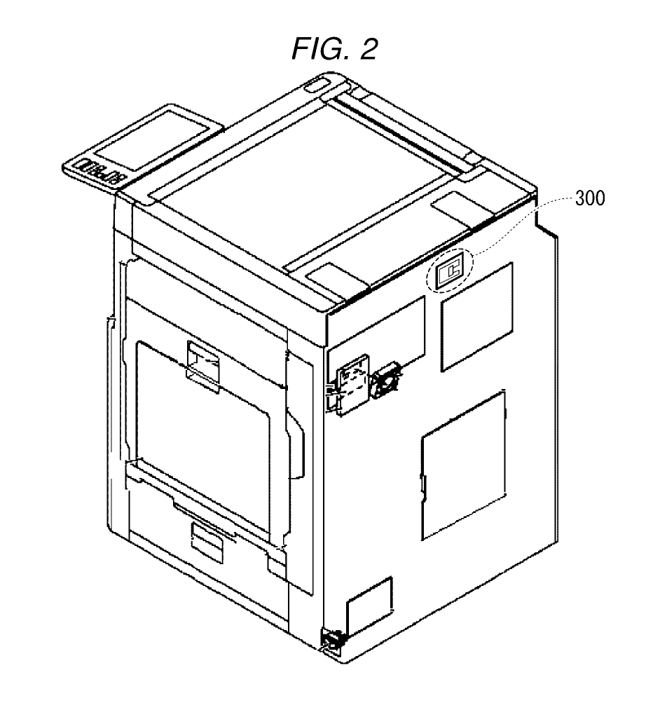

FIG. 2 is a diagram which illustrates an example of a built-in place of an IC tag which is built in the image forming apparatus 100 in the embodiment. According to FIG. 2, an IC tag 300 is built in the rear face of the image forming apparatus 100. The IC tag 300 stores apparatus specific information. The apparatus specific information denotes a specification of the image forming apparatus 100 in which the IC tag 300 is built. The apparatus specific information includes at least a manufacturing number, a model number, a serial number, and speed information.

The manufacturing number is a number which can uniquely identify the image forming apparatus 100. A different manufacturing number is given to a different image forming apparatus 100. Accordingly, a manufacturing number which is stored in the IC tag 300 is the same as that of the image forming apparatus 100 in which the IC tag 300 is built. The manufacturing number may be configured of a number, or may be configured by combining characters such as an alphabet and a number. The IC tag 300 is set to make a one-to-one correspondence with the image forming apparatus 100 by recording the manufacturing number.

The model number is a number with which it is possible to identify a model of the image forming apparatus 100. When it is an image forming apparatus 100 with the same model, the same model number is given. Accordingly, a model number which is recorded by the IC tag 300 is different in each model of the image forming apparatus 100. The model number may be configured of numbers, or may be configured by combining characters such as an alphabet and numbers.

The serial number is a consecutive number of the image forming apparatus 100. A different serial number is given to a different image forming apparatus 100. As the serial number, an incremented value is given to each model in order of manufacturing, for example. Accordingly, a different serial number is given to an image forming apparatus 100 with the same model number. However, there is a case in which the same serial number is given to an image forming apparatus 100 with a different model number. The serial number is configured of numbers.

The speed information is information which denotes a printing speed of a rated value of the image forming apparatus 100. The printing speed denotes how many sheets are printed per unit time. For example, when the printing speed is 50 pieces/minute, the image forming apparatus 100 denotes that it is possible to print 50 sheets per minute. The printing speed is predetermined in each model number. The printing speed may be different depending on whether it is monochrome printing or color printing. In this case, the IC tag stores a printing speed in monochrome printing and a printing speed in color printing as speed information.

The IC tag 300 includes a wireless communication function such as RFID, for example. The IC tag 300 transmits the apparatus specific information which is stored in the IC tag 300 using power which is generated when receiving an electric wave. It is preferable that the IC tag 300 have a shape which is damaged when being peeled, for example, like a VOID seal. The IC tag 300 is one form of a storage device. The storage device stores the printing speed of the rated value of the image forming apparatus 100, and second identification information with which it is possible to uniquely identify the image forming apparatus 100. The manufacturing number recorded in the IC tag is one form of the second identification information. The second identification information is information with which it is possible to uniquely identify the image forming apparatus 100.

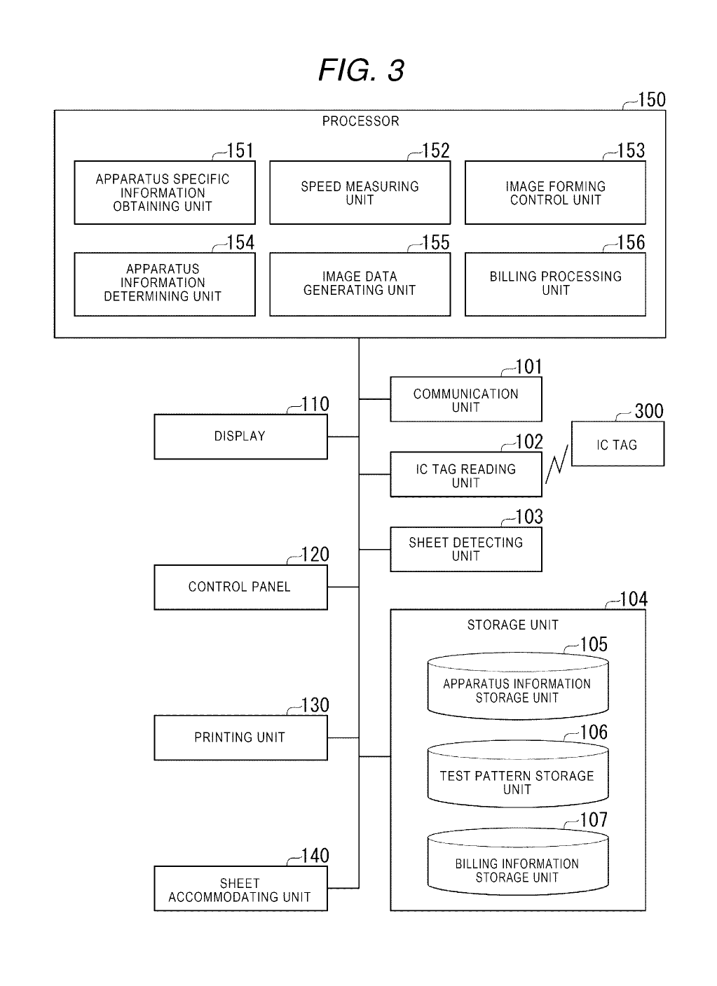

FIG. 3 is a functional block diagram which denotes a configuration of the image forming apparatus according to the embodiment. The image forming apparatus 100 is provided with a communication unit 101, an IC tag reading unit 102, a sheet detecting unit 103, a storage unit 104, the display 110, the control panel 120, the printing unit 130, the sheet accommodating unit 140, a processor 150, and the IC tag 300. Descriptions of configurations of the display 110, the control panel 120, the printing unit 130, the sheet accommodating unit 140, and the IC tag 300 will be omitted.

The communication unit 101 is a network interface. The communication unit 101 is communicably connected to an external terminal such as a personal computer, a smart phone, a tablet computer, or a server through a network. The communication unit 101 is connected using a communication method such as a local area network (LAN), or public switched telephone networks (PSTN), for example.

The IC tag reading unit 102 obtains the apparatus specific information which is recorded in the IC tag 300. The IC tag reading unit 102 is, for example, a reading device such as an IC tag reader. The IC tag reading unit 102 causes power to be generated in the IC tag 300 by generating an electric wave. The IC tag reading unit 102 obtains the apparatus specific information by reading the apparatus specific information which is transmitted by the IC tag 300 using the generated power. The IC tag reading unit 102 transmits the obtained apparatus specific information to the processor 150.

The sheet detecting unit 103 detects a sheet which is transported through the inside of the image forming apparatus 100. The sheet detecting unit 103 is a sensor which detects that the sheet is transported to a predetermined place. The sheet detecting unit 103 transmits a signal denoting that the sheet is transported to the processor 150, when the sheet approaches a predetermined place, or passes through the predetermined place. The predetermined place is a transport path of the sheet, and may be any place when it is a place in which the sheet detecting unit 103 can detect arrival of the sheet. The sheet detecting unit 103 may be provided in the vicinity of a discharging port of the transport path, for example. As the sheet detecting unit 103, a jamming detecting sensor may be used.

The storage unit 104 stores various data which is used in order to detect an unfair modification with respect to the image forming apparatus 100. The storage unit 104 is configured of a storage device such as a magnetic hard disk device, a semiconductor storage device, a random access memory (RAM), or the like. The storage unit 104 is provided with an apparatus information storage unit 105, a test pattern storage unit 106, and a billing information storage unit 107.

The processor 150 controls an operation of each unit of the image forming apparatus 100. The processor 150 is executed by a device which is provided with a processor such as a central processing unit (CPU) and a RAM, for example. The processor 150 functions as an apparatus specific information obtaining unit 151, a speed measuring unit 152, an image forming control unit 153, an apparatus information determining unit 154, an image data generating unit 155, and a billing processing unit 156, by executing a modification detecting program. The processor 150 is one form of a control unit. The control unit limits executing of at least a part of functions which are provided in the image forming apparatus 100 when it is determined that the image forming apparatus 100 is subjected to a modification. The limitation of executing of the function may be a stop of printing by the printing unit 130, or may be setting of a printing speed so as to be a rated value or less.

The apparatus information storage unit 105 records the apparatus specific information and the apparatus information. The apparatus specific information is the apparatus specific information which is obtained from the IC tag 300. The apparatus information is information which denotes a specification of the image forming apparatus 100. The apparatus information includes at least a manufacturing number, a model number, a serial number, and a measured speed. The manufacturing number, the model number, and the serial number are stored in advance. Since the manufacturing number, the model number, and the serial number are the same information as that of the apparatus specific information, descriptions thereof are omitted. The measured speed denotes a speed which is measured when the image forming apparatus 100 prints a sheet. The measured speed is measured by the speed measuring unit 152. The manufacturing number recorded in the apparatus information storage unit 105 is one form of first identification information. The first identification information is information with which it is possible to uniquely identify the image forming apparatus 100.

The test pattern storage unit 106 records test pattern image data. The test pattern image data is data which is used in printing of the test pattern image. The test pattern image data may be image data which is obtained by disposing a grayscale patch image of each color of CMYK in the main scanning direction. The test pattern image data is recorded in the test pattern storage unit 106 in advance. The test pattern image data may be recorded as image data for monochrome or image data for color, respectively.

The billing information storage unit 107 records the billing information table. The billing information table is used in order to determine a charge for billing with respect to a user of the image forming apparatus 100. The billing information table is updated by the billing processing unit 156 when a sheet is printed. A user may be a user of the image forming apparatus 100, or may be an owner of the image forming apparatus 100.

The billing information storage unit 107 stores a unit price of monochrome printing, and a unit price of color printing per piece, when unfair modification is not performed. The billing information storage unit 107 stores a unit price of monochrome printing, and a unit price of color printing per piece, when unfair modification is performed. In addition, the billing information storage unit 107 may store an offset value which is added to a unit price of printing when unfair modification is not performed, in a case in which unfair modification is performed.

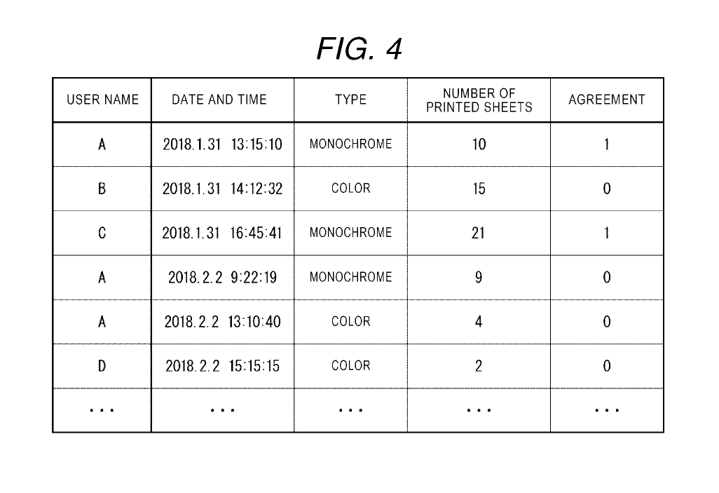

FIG. 4 is a diagram which illustrates a specific example of the billing information table in the embodiment. The billing information table includes a billing information record. The billing information table includes a user name, a date and time, a type, the number of printed pieces, and each value of an agreement. The user name is identification information for identifying a user who performed printing. The date and time denotes a date and time in which printing is performed. The type denotes whether a sheet is subjected to monochrome printing or color printing. The number of printed pieces denotes the number of sheets which is actually printed. The agreement denotes whether or not an agreement is obtained when printing is performed at a cost of a printing unit price in a case of unfair modification, when unfair modification is performed in the image forming apparatus 100. For example, according to FIG. 4, when an agreement is selected, 1 is recorded. When an agreement is not selected, or unfair modification is not performed, 0 is recorded.

In the example illustrated in FIG. 4, a billing information record on the top of the billing information table, a value of a user name is “A”, and a value of a date and time is 2018. 1. 31. 13:15:10”. Therefore, according to the record on the top of the billing information table, it is understood that a user who performed printing is “A”, printing is performed at 13 o'clock 15 minutes and 10 secs, on Jan. 31, 2018, and 10 pieces are printed in monochrome. In addition, it is understood that the image forming apparatus 100 is subjected to unfair modification. It is understood that “A” agreed with printing in the printing unit price when unfair modification is performed. In addition, the billing information table illustrated in FIG. 4 is merely a specific example. For this reason, a billing information table may be configured in a form different from the billing information table in FIG. 4.

Returning to FIG. 3, descriptions of the image forming apparatus 100 will be continued. The apparatus specific information obtaining unit 151 causes the IC tag reading unit 102 to transmit an electric wave. The apparatus specific information obtaining unit 151 obtains the apparatus specific information which is transmitted to the processor 150 by the IC tag reading unit 102. The apparatus specific information obtaining unit 151 records the obtained apparatus specific information in the apparatus information storage unit 105. The apparatus specific information obtaining unit 151 is one form of the speed information obtaining unit. The speed information obtaining unit obtains a printing speed of a rated value of the image forming apparatus 100 from the storage device such as the IC tag 300.

The speed measuring unit 152 determines a printing speed of the image forming apparatus 100. The speed measuring unit 152 determines the printing speed of the image forming apparatus 100 based on an interval of a signal which is transmitted to the processor 150 by the sheet detecting unit 103. Specifically, the speed measuring unit 152 specifies a time interval between a signal denoting an arrival of a first sheet and a signal denoting an arrival of a second sheet which is continuously transmitted. The speed measuring unit 152 determines the printing speed by dividing a unit time which is designated in advance by a specified time interval. For example, it is assumed that a unit time is 1 minute (60 secs). A time interval between the signal denoting an arrival of the first sheet and a signal denoting an arrival of the second sheet is 2 secs. In this case, the speed measuring unit 152 determines that the printing speed is 30 pieces/minute. The speed measuring unit 152 records the determined printing speed in the apparatus information storage unit 105 as a measured speed.

The image forming control unit 153 performs printing on a sheet by controlling the printing unit 130. When receiving a predetermined instruction, the image forming control unit 153 performs printing on the sheet according to the instruction. The predetermined instruction may be an instruction for receiving a fax, copying instruction, ora printing instruction. The predetermined instruction is received from the communication unit 101 or the control panel 120 as a printing job. The image forming control unit 153 outputs the number of printed sheets to the billing processing unit 156. The image forming control unit 153 outputs information denoting whether it is monochrome printing or color printing to the billing processing unit 156. In addition, the image forming control unit 153 outputs a user name who gives a printing instruction such as a copying instruction or a printing instruction, or a printed date and time to the billing processing unit 156.

The apparatus information determining unit 154 determines whether or not unfair modification is performed in the image forming apparatus 100 based on the apparatus specific information and the apparatus information. The unfair modification may be a state in which a printing program of the image forming apparatus 100 is altered, or a state in which a base of the image forming apparatus 100 is altered, for example. The image forming apparatus 100 can perform printing at a printing speed which is different from a printing speed which is designed in advance, due to an unfair modification.

The apparatus information determining unit 154 determines that unfair modification is performed in the image forming apparatus 100, for example, when the speed information included in the apparatus specific information and the measured speed included in the apparatus information satisfy a predetermined condition. The predetermined condition may be a case in which the speed information and the measured speed are different, or may be a case in which a difference between the speed information and the measured speed is larger than a predetermined threshold value. In addition, the apparatus information determining unit 154 may determine that the unfair modification is also performed in a case in which the apparatus specific information is not recorded in the apparatus information storage unit 105. The apparatus information determining unit 154 outputs a determination result to the image data generating unit 155 and the billing processing unit 156.

The apparatus information determining unit 154 may determine whether or not the unfair modification is performed based on another information without being limited to the speed information and the measured speed. For example, the apparatus information determining unit 154 may determine that the unfair modification is performed when the manufacturing number included in the apparatus specific information and the manufacturing number included in the apparatus information do not match, or when a combination of the model number and the serial number included in the apparatus specific information and a combination of the model number and the serial number included in the apparatus information do not match, a determination may be made that the unfair modification is performed. The apparatus information determining unit 154 is one form of the determining unit. When the speed information and the measured speed satisfy the predetermined condition, the determining unit determines that a modification is performed in the image forming apparatus 100.

The image data generating unit 155 generates image data which is displayed on the display 110. When a determination result received from the apparatus information determining unit 154 is a determination result denoting that the unfair modification is performed, the image data generating unit 155 generates image data denoting a condition for executing a printing function (hereinafter, referred to as “conditional image data”). For example, since the conditional image data is the image forming apparatus 100 in which the unfair modification is performed, it may be image data in which words which say that an amount of fee which is larger than a regulated fee is charged when printing is performed are included. The conditional image data may be image data for obtaining an agreement regarding charging of a large amount of fee, relating to a condition for executing the printing function with respect to a user. For example, the condition for executing the printing function is a condition in which an amount of money which is larger than that in the case in which the unfair modification is not performed in the image forming apparatus 100 is charged. In this case, the control panel 120 receives a selection for an agreement or a selection for a disagreement from a user, related to charging of a large amount of fee. The image data generating unit 155 outputs the selected result to the image forming control unit 153 and the billing processing unit 156.

When the control panel 120 receives a selection of disagreement, the image data generating unit 155 generates image data of requesting a user to repair the image forming apparatus 100 so as to return to the state before being subjected to the unfair modification (hereinafter, referred to as “image data for requesting repair”). The image data generating unit 155 causes the generated conditional image data or the image data for requesting repair to be displayed on the display 110. When the image data for requesting repair is displayed, the image forming apparatus 100 may cause the image data for requesting repair to be displayed, may return to a standby state, after a predetermined time, or may set to a state of not allowing printing until the image forming apparatus 100 is repaired so as to return to the state before being subjected to the unfair modification. The standby state is a state of receiving a printing instruction, or the like. The image data generating unit 155 may cause conditional image data which is stored in advance, or the image data for requesting repair to be displayed on the display 110.

The billing processing unit 156 determines an amount of money to be billed with respect to a user of the image forming apparatus 100. The billing processing unit 156 records a user name, a date and time in which printing is performed, whether it is monochrome printing or color printing, the number of printed sheets, and a selection result of agreement or disagreement which are received from the image forming control unit 153 in the billing information table as a billing information record.

The billing processing unit 156 determines an amount of money to be billed based on the number of printed sheets and the printing unit price which are recorded in the billing information storage unit 107 at a predetermined timing. The predetermined timing may be a timing which is instructed by a service man, may be a date and time which is designated in advance, or may be a timing generated by the billing information record, for example.

A method of determining the amount of money to be billed using the billing processing unit 156 will be described using FIG. 4. The billing processing unit 156 calculates an amount of money to be billed on Jan. 31, 2018, as an example. The billing processing unit 156 obtains a billing information record of which a date and time is Jan. 31, 2018 from the billing information table. The billing processing unit 156 calculates an amount of money to be billed in each of the obtained billing information record. Specifically, when a value of agreement is 1, the billing processing unit 156 calculates an amount of money to be billed based on a printing unit price when the unfair modification is performed. For example, when it is the billing information record on the top in which a value of a type is “monochrome”, and the number of printed sheets is “10”, the billing processing unit 156 calculates a monochrome printing unit priceX10 when the unfair modification is performed as the amount of money to be billed. When a value of agreement is 0, the billing processing unit 156 calculates an amount of money to be billed based on a printing unit price when the unfair modification is not performed. For example, when it is the second billing information record from the top in which a value of a type is “color”, and the number of printed sheets is “15”, the billing processing unit 156 calculates a color printing unit priceX15 when the unfair modification is not performed as an amount of money to be billed. The billing processing unit 156 determines a total sum of the amount of money to be billed in each billing information record which is calculated as an amount of money to be billed with respect to a user. In addition, a period in which the amount of money to be billed is determined is not limited to a unit of one day. The billing processing unit 156 may determine the amount of money to be billed in a predetermined period such as one week, one month, one year, or the like.

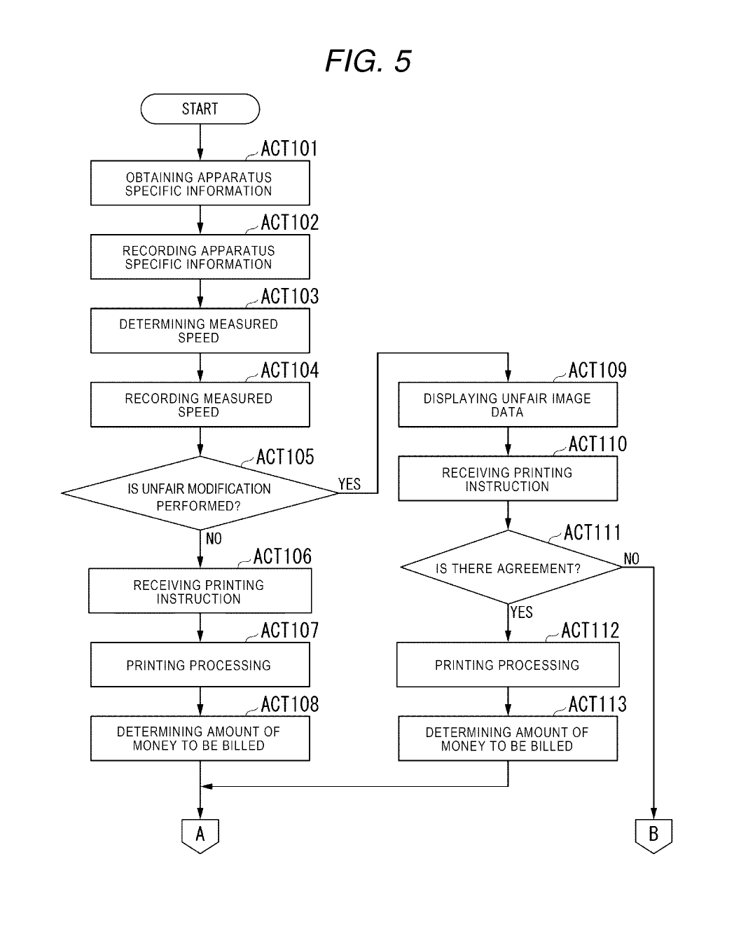

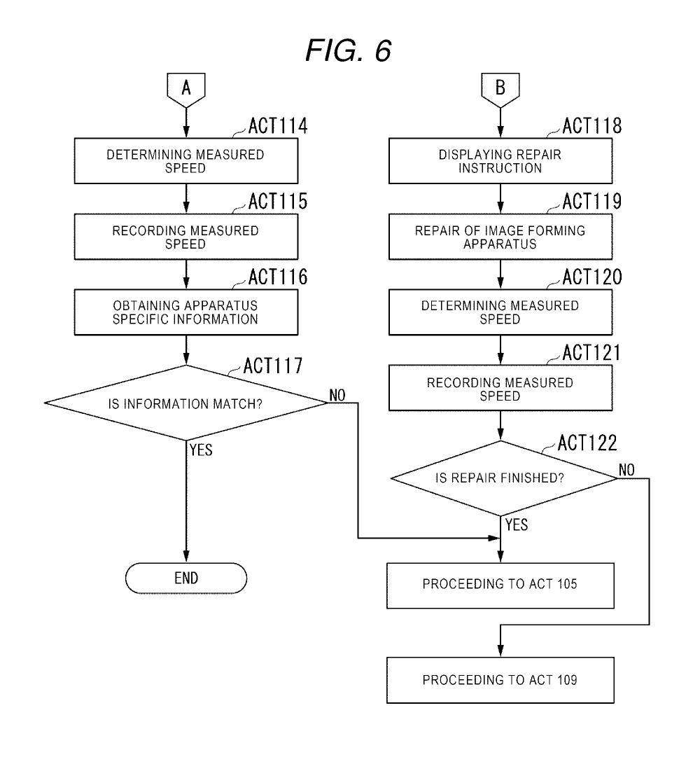

FIGS. 5 and 6 are flowcharts which illustrate a flow of determining processing in which whether or not the unfair modification of the image forming apparatus in the embodiment is performed. The apparatus specific information obtaining unit 151 of the image forming apparatus 100 obtains the apparatus specific information from the IC tag 300 by transmitting an electric wave to the IC tag reading unit 102, when a power supply of the image forming apparatus 100 is turned on (ACT 101). The apparatus specific information obtaining unit 151 records the obtained apparatus specific information in the apparatus information storage unit 105 (ACT 102).

The sheet detecting unit 103 of the image forming apparatus 100 transmits a signal denoting a transport of a sheet to the processor 150 when the sheet approaches or passes through. The speed measuring unit 152 of the image forming apparatus 100 determines a printing speed of the image forming apparatus 100 based on an interval of signals which are transmitted to the processor 150 by the sheet detecting unit 103 (ACT 103). In addition, when the power supply of the image forming apparatus 100 is turned on, the image forming control unit 153 causes the printing unit 130 to print two test patterns. That is, the sheet detecting unit 103 transmits a signal to the processor 150 by detecting a sheet on which a test pattern image is printed. The speed measuring unit 152 records a determined printing speed in the apparatus information storage unit 105 as a measured speed (ACT 104).

The apparatus information determining unit 154 of the image forming apparatus 100 determines whether or not the unfair modification is performed in the image forming apparatus 100 based on the printing speed included in the apparatus specific information and the determined measured speed (ACT 105). Specifically, the apparatus information determining unit 154 determines that the unfair modification is performed when the measured speed is higher than the printing speed. When the apparatus information determining unit 154 determines that the unfair modification is performed (Yes in ACT 105), the process proceeds to ACT 109.

When the apparatus information determining unit 154 determines that the unfair modification is not performed (No in ACT 105), the image forming control unit 153 receives a printing instruction such as a copying instruction or a print instruction (ACT 106). The image forming control unit 153 executes printing processing based on the received printing instruction (ACT 107). The image forming control unit 153 outputs information denoting the number of printed sheets, and whether it is monochrome printing or color printing to the billing processing unit 156. In addition, the image forming control unit 153 outputs a user name who gives the printing instruction and the date and time in which printing is performed to the billing processing unit 156. The billing processing unit 156 determines an amount of money to be billed based on the output information (ACT 108). In a case of ACT 108, the billing processing unit 156 determines the amount of money to be billed based on the printing unit price when the unfair modification is not performed. When ACT 108 is finished, the process proceeds to ACT 114.

In ACT 109, the processor 150 of the image forming apparatus 100 limits executing of a part of functions provided in the image forming apparatus. The image data generating unit 155 of the image forming apparatus 100 generates conditional image data. The image data generating unit 155 causes the conditional image data to be displayed on the display 110 (ACT 109). The image forming control unit 153 receives a printing instruction such as a copying instruction or a print instruction (ACT 110). When receiving the printing instruction, the control panel 120 receives a selection of agreement or a selection of disagreement from a user with respect to billing of a large amount of fee (ACT 111). The image data generating unit outputs the selected result to the image forming control unit 153 and the billing processing unit 156. When receiving a selection of disagreement (No in ACT 111), the process proceeds to ACT 118.

When receiving a selection of agreement (Yes in ACT 111), the image forming control unit 153 executes printing processing based on the received printing instruction (ACT 112). The image forming control unit 153 outputs the number of printed sheets, and information denoting whether it is monochrome printing or color printing to the billing processing unit 156. In addition, the image forming control unit 153 outputs a user name who gives the printing instruction, and a date and time in which printing is performed to the billing processing unit 156. The billing processing unit 156 determines an amount of money to be billed based on the output information (ACT 113). In a case of ACT 113, the billing processing unit 156 determines the amount of money to be billed based on a printing unit price when the unfair modification is performed. When ACT 113 is finished, the process proceeds to ACT 114.

In ACT 114, the sheet detecting unit 103 transmits a signal denoting an arrival of a sheet to the processor 150 when the sheet printed in ACT 107 approaches or passes through. The speed measuring unit 152 of the image forming apparatus 100 determines a printing speed of the image forming apparatus 100 based on an interval of signals which are transmitted to the processor 150 by the sheet detecting unit 103 (ACT 114). The speed measuring unit 152 records the determined printing speed in the apparatus information storage unit 105 as the measured speed (ACT 115).

The apparatus specific information obtaining unit 151 obtains the apparatus specific information from the IC tag 300 by causing the IC tag reading unit 102 to transmit an electric wave (ACT 116). The apparatus information determining unit 154 determines whether or not information includes in the apparatus specific information and information included in the apparatus information match (ACT 117). For example, the apparatus information determining unit 154 may determine whether or not the manufacturing number included in the apparatus specific information and the manufacturing number included in the apparatus information match, or may determine whether or not a combination of the model number and the serial number matches. When information included in the apparatus specific information and the information included in the apparatus information match (Yes in ACT 117), the process is finished. When information included in the apparatus specific information and the information included in the apparatus information does not match (No in ACT 117), the process proceeds to ACT 105.

In ACT 118, the image data generating unit 155 of the image forming apparatus 100 generates the image data for requesting repair. The image data generating unit 155 causes the image data for requesting repair to be displayed on the display 110 (ACT 118). The image forming apparatus 100 receives repair (ACT 119). The repair is performed by a person in charge of maintenance such as a service man or a user. The repair is, for example, processing of returning software to a version before being subjected to the unfair modification, or processing in which a base of the image forming apparatus 100 is exchanged. The image forming apparatus 100 can print a sheet at a printing speed before being subjected to the unfair modification, when the repair is normally finished.

When repair is finished, the image forming control unit 153 causes the printing unit 130 to print two test pattern images. The sheet detecting unit 103 transmits a signal denoting a transport of a sheet to the processor 150, when the sheet on which the test pattern is printed approaches or passes through. The speed measuring unit 152 of the image forming apparatus 100 determines a printing speed of the image forming apparatus 100 based on an interval of signals which are transmitted to the processor 150 by the sheet detecting unit 103 (ACT 120). The speed measuring unit 152 records the determined printing speed in the apparatus information storage unit 105 as the measured speed (ACT 121).

The apparatus information determining unit 154 of the image forming apparatus 100 determines whether or not repair of the image forming apparatus 100 is finished based on the printing speed and the measured speed which are included in the apparatus specific information (ACT 122). When the apparatus information determining unit 154 determines that the repair of the image forming apparatus 100 is finished (Yes in ACT 122), the process proceeds to ACT 105. When apparatus information determining unit 154 determines that the repair of the image forming apparatus 100 is not finished (No in ACT 122), the process proceeds to ACT 109.

In the image forming apparatus 100 which is configured in this manner, the IC tag reading unit 102 obtains the apparatus specific information from the IC tag 300. The speed measuring unit 152 generates the measured speed based on the signal received from the sheet detecting unit 103. The apparatus information determining unit 154 determines whether or not the speed information included in the apparatus specific information and the generated measured speed satisfy the predetermined condition. The apparatus information determining unit 154 determines whether or not the unfair modification is performed in the image forming apparatus 100 according to the determination result. When the unfair modification is performed, the image data generating unit 155 causes the conditional image data to be displayed on the display 110. In the conditional image data, an image requesting for an agreement related to billing of a large amount of fee with respect to a user is included, when printing is performed. The control panel 120 receives a selection of agreement or a selection of disagreement related to billing of a large amount of fee from a user. The image forming control unit 153 performs printing when an agreement is selected. When the agreement is selected, the billing processing unit 156 calculates an amount of money to be billed using a printing unit price when the unfair modification is performed. Accordingly, since a large amount of fee is billed when the image forming apparatus 100 in which the unfair modification is performed performs printing, it is possible to suppress the unfair modification with respect to the image forming apparatus 100, and the image forming apparatus is used in a normal state.

When disagreement is selected, since the image forming apparatus 100 does not perform printing, convenience for a user is lost. Accordingly, the image forming apparatus is used in a normal state, since the unfair modification is suppressed. In addition, when the unfair modification is performed, since unfair image data is displayed, and it is annoying for a user, the unfair modification is suppressed. In addition, when disagreement is selected, the image forming control unit 153 may be configured so that the operation is stopped until being repaired so as to return to the state before being subjected to the unfair modification.

### Modification Example of Embodiment

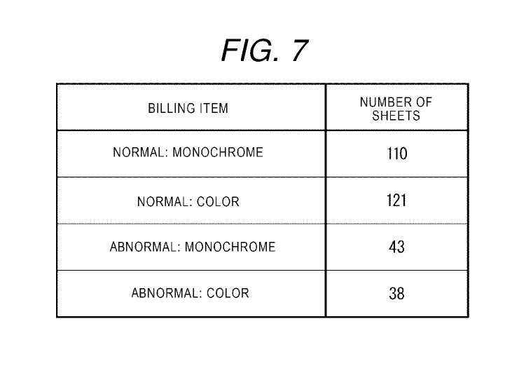

FIG. 7 is a diagram which illustrates a second specific example of the billing information table in the embodiment. The billing information storage unit 107 may store the table illustrated in FIG. 7 as the billing information table. In the billing information table denoted in FIG. 7, the number of printed sheets when the unfair modification is not performed and the number of printed sheets when the unfair modification is performed are respectively recorded for each of monochrome printing and color printing.

In this case, the billing processing unit 156 counts a value of a column of the number of sheets based on information denoting whether it is monochrome printing or color printing which is received from the image forming control unit 153, and the printed number of sheets. Specifically, when receiving information denoting agreement from the image data generating unit 155, the billing processing unit 156 counts a value of the column of the number of sheets of “abnormal: monochrome”, or “abnormal: color”. When information denoting agreement is not received from the image data generating unit 155, the billing processing unit 156 counts a value of a column of the number of sheets of “normal: monochrome”, or “normal: color”.

The billing processing unit 156 determines an amount of money to be billed based on the printed number of sheets and the printing unit price which are recorded in the billing information storage unit 107 at a predetermined timing. The predetermined timing may be a timing which is instructed by a service man, may be a date and time which is designated in advance, or may be a timing in which the billing information record is generated, for example. By configuring in this manner, the billing processing unit 156 can determine an amount of money to be billed.

When receiving information denoting agreement from the image data generating unit 155, the billing processing unit 156 may be configured so that an amount of money to be billed is determined to be a large amount of fee until a repair of the image forming apparatus 100 is normally finished. In this case, the image forming apparatus 100 performs printing at a printing speed in the unfairly modified state. By configuring in this manner, it is not necessary for a user who uses the image forming apparatus 100 to input a selection of agreement through the control panel 120, every time the user performs printing.

When the control panel 120 receives a selection of disagreement, the image forming control unit 153 may be configured so as to print a sheet at a printing speed included in the apparatus specific information, or a printing speed which is slower than the printing speed included in the apparatus specific information. By configuring in this manner, a user can continuously use the image forming apparatus, even when the image forming apparatus 100 is subjected to the unfair modification.

The image forming apparatus 100 may be configured so as to execute processing which is not accompanied by a printing function such as receiving of a fax and reading of an image, even when the control panel 120 receives a selection of disagreement. By configuring in this manner, it is possible to continuously use the image forming apparatus, related to processing which is regardless of the unfair modification, and maintain convenience.

A storage device which records the apparatus specific information, and is built in the image forming apparatus 100 is not limited to the IC tag 300. For example, the device may be any device, when it is a storage device such as an SD card, a USB memory, and an HDD, instead of the IC tag 300.

While certain embodiments have been described these embodiments have been presented by way of example only, and are not intended to limit the scope of the inventions. Indeed, the novel embodiments described herein may be embodied in a variety of other forms: furthermore various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. An image forming apparatus comprising:
a speed information obtaining unit which obtains a printing speed of a rated value of the image forming apparatus;
a speed measuring unit which determines a measured speed which denotes a printing speed when a sheet is printed by the image forming apparatus; and
a determining unit which determines that the image forming apparatus is subjected to a modification when the printing speed and the measured speed satisfy a predetermined condition.

2. The apparatus according to claim 1, further comprising:
a control unit which limits an execution of at least a part of functions provided in the image forming apparatus, when it is determined that the modification is performed in the image forming apparatus.

3. The apparatus according to claim 1, further comprising:
a storage device in which the printing speed of the rated value is recorded,
wherein the speed information obtaining unit obtains the printing speed of the rated value from the storage device.

4. The apparatus according to claim 1, further comprising:
a sheet detecting unit which detects that a sheet is transported to a predetermined place on a transport path of the image forming apparatus,
wherein the speed measuring unit determines the measured speed based on a time interval at which the sheet detecting unit detects a first sheet, and a second sheet which is transported subsequent to the first sheet.

5. The apparatus according to claim 4,
wherein the printing unit prints a plurality of test pattern images which are designated in advance, when a power supply is input to the image forming apparatus.

6. The apparatus according to claim 2, further comprising:
an image data display unit which displays conditional image data which denotes a condition for executing a limited function;
a control panel which receives an instruction of whether to agree with the condition or not, when the conditional image data is displayed on a display device; and
a printing unit which performs printing when the control panel receives the instruction of agreeing with the condition.

7. The apparatus according to claim 6, further comprising:
a billing processing unit which charges an amount of money which is larger than an amount of money in a case in which the modification is not performed, with respect to a user of the image forming apparatus, when receiving the instruction of agreeing with the condition.

8. The apparatus according to claim 6,
wherein the printing unit does not perform printing when the control panel receives an instruction of not agreeing with the condition.

9. The apparatus according to claim 6,
wherein, when the control panel receives an instruction of agreeing with the condition, the printing unit performs printing on a sheet at a printing speed of the printing speed or less.

10. An image forming method of an image forming apparatus comprising:
obtaining a speed information of a printing speed of a rated value of the image forming apparatus;
measuring a speed in which a measured speed which denotes a printing speed when a sheet is printed by the image forming apparatus is determined; and
determining that the image forming apparatus is subjected to a modification when the printing speed and the measured speed satisfy a predetermined condition.
